(19) United States
(12) Patent Application Publication
(10) Pub. No.: US 2007/0039405 A1
(43) Pub. Date: Feb. 22, 2007

(54) Reacting force controller for accelerator pedal

(76) Inventors: Kyung Min Kim, Busan (KR); Choong Suk Ok, Busan (KR)

Correspondence Address: DICKSTEIN SHAPIRO LLP, 1825 EYE STREET NW, Washington, DC, 20006-5403, US

(21) Appl. No.: 11/495,561

(22) Filed: Jul. 31, 2006

(30) Foreign Application Priority Data
Aug. 22, 2005 (KR) 10-2005-0076690

(51) Int. Cl. G05G 1/14

(52) U.S. Cl. 74/512

(57) ABSTRACT

When a driver presses an accelerator pedal to the maximum stroke, apart from the linear variation of the elastic force by a return spring mounted to return the accelerator pedal, an additional momentary change in force by a turn-over spring is transmitted to the driver, so that a reacting-force controller for an accelerator pedal, which allows a driver to sense an instant catch when pressing the accelerator pedal to the maximum stroke.

### BACKGROUND OF THE INVENTION

1. Field of the Invention

The present invention relates to a reacting force controller for an accelerator pedal, particularly a controller allowing a driver to sense that an accelerator pedal of a vehicle is pressed to the maximum stroke through the accelerator pedal.

2. Description of the Related Art

An accelerator pedal is generally fixed to a chassis by a hinge and receives elastic force by a coil spring-typed return spring, so that in case of pressing the accelerator pedal, a driver senses elastic force by the return spring that linearly increases through the accelerator pedal.

The linear force transmitted as described above is continued until the accelerator pedal is pressed to the maximum stroke and cannot pivot any more. Therefore, the driver cannot surely recognize that the accelerator pedal is pressed to the maximum stroke until the accelerator pedal is not pressed any more.

In particular, in conventional vehicles including an accelerator pedal and a throttle valve that are mechanically connected, as the accelerator pedal is pressed, changes in force resulting from the mechanical operation of the throttle valve and the operation of a mechanism connecting the accelerator pedal and the throttle valve are transmitted to a driver through the accelerator pedal. Therefore, only sensitive drivers could sense changes in the stroke of the accelerator pedal. However, in recent times, an electric throttle unit and an electric accelerator pedal are not provided with a mechanical connection for transmitting changes in force, so that a driver can simply sense the operation of the accelerator pedal.

### SUMMARY OF THE INVENTION

Accordingly, an object of the present invention is to provide a reacting force controller for an accelerator pedal that is configured such that additional momentary changes in force as well as variation in the linear elastic force by a return spring provided to return the accelerator pedal is transmitted to a driver through the accelerator pedal when the accelerator pedal is pressed to the maximum stroke in order to allow the driver to sense an instant catch when pressing the accelerator pedal to the maximum stroke.

A reacting force controller, for an accelerator pedal of the invention, to accomplish the above objects includes an accelerator pedal, a turn-over spring that is composed of a circularly wound coil, a first arm and a second arm extending from the coil in two directions and having pivots curved to be parallel with the central axis of the coil, and a power transmitting unit that transmits pivoting motion of the accelerator pedal in a predetermined section of the entire pivoting stroke of the accelerator pedal to the turn-over spring, in which the turn-over spring is disposed such that the pivot of the first or second arm of the turn-over spring approaches the pivot of the other arm, and is then returned by a force continuously transmitted unidirectionally through the power transmitting unit from the accelerator pedal.

### BRIEF DESCRIPTION OF THE DRAWINGS

The above and other features and advantages of the present invention will become more apparent by describing in detail preferred embodiments thereof with reference to the attached drawings in which:

FIG. 1 shows a graph illustrating operation characteristics, intended by the invention, of a reacting force controller for an accelerator pedal;

FIGS. 2 and 3 are views illustrating an embodiment that is provided with a reacting force controller for an accelerator pedal of the invention;

FIG. 4 is a view illustrating the operation of a reacting force controller for an accelerator pedal;

FIG. 5 is a view illustrating another embodiment of the invention; and

FIG. 6 is a view for comparing the two embodiments of the invention.

### DESCRIPTION OF THE PREFERRED EMBODIMENTS

Hereinafter, the preferred embodiments of the present invention will be described.

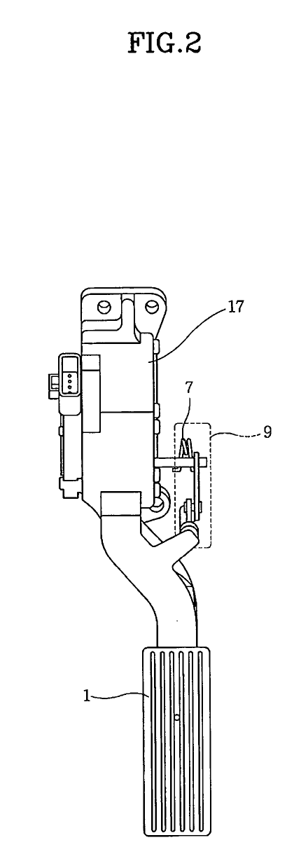

Referring to FIGS. 2 to 4, a reacting force controller for an accelerator pedal according to an embodiment of the present invention includes an accelerator pedal 1, a turn-over spring 7 that is composed of a circular wired coil, a first arm 3 and second arm 5 respectively extending from the coil in two directions and respectively having a pivot curved to be parallel with the axis of the coil, and a power transmitting unit that transmits pivoting motion of the accelerator pedal 1 in a predetermined section of the entire pivoting stroke of the accelerator pedal 1, in which the turn-over spring 7 is disposed such that a pivot of either the first arm 3 or second arm 5 of the turn-over spring 7 approaches the pivot of the other arm and is returned by a force continuously transmitted in a direction through the power transmitting unit from the accelerator pedal 1.

In the above embodiment, the power transmitting unit includes a body 9 that is constantly fixed regardless of the motion of the accelerator pedal 1, a plunger 11 that is provided in the body 9 to slide linearly as the accelerator pedal pivots, a supporting spring 13 that elastically supports the plunger 11 that is to be pushed toward the accelerator pedal 1, and a lever 15 that is provided in the body 9 to pivot as the plunger linearly slides.

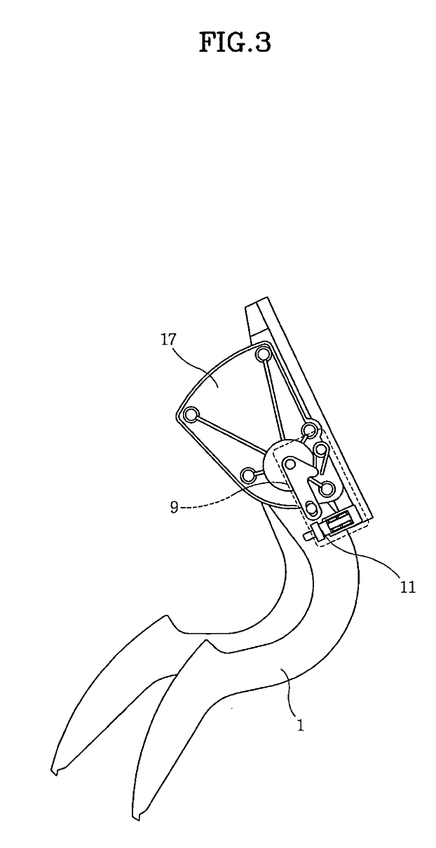

When used for the electric accelerator pedal 1 shown in FIGS. 2 and 3, the body 9 is constantly fixed with respect to a pedal unit housing 17 provided with the accelerator pedal 1 or fixed to the chassis, so that it ensures the fixed state regardless of the motion of the accelerator pedal 1.

The present invention may also be applied to conventional mechanical accelerator pedals, in which the body 9 is fixed to a chassis or a pedal-mounting bracket to which the accelerator pedal 1 is fixed, so that it also ensures the fixed state regardless of the motion of the accelerator pedal 1.

The plunger 11 should slide parallel with the tangential line to the arc constructed as the accelerator pedal 1 pivots to be slidable in the body 9 by the accelerator pedal 1.

As described above, the body 9 and the plunger 11 should be disposed with respect to the accelerator pedal 1 such that pivoting motion of the accelerator pedal 1 can be transmitted to the turn-over spring 7 in a predetermined section of the entire pivoting stroke of the accelerator pedal 1. In more details, the body 9 and the plunger 11 should be disposed at a position where the pivoting accelerator pedal 1 can press the plunger 11 in the predetermined section right before the accelerator pedal 1 is pressed to the maximum so that sensible force through the accelerator pedal 1 rapidly changes right before the accelerator pedal 1 is pressed to the maximum stroke to correspond to the object of the invention.

The turn-over spring 7 is disposed such that an elastic force acting between the body 9 and lever 15 increases or decreases depending on the pivoting angle of the lever 15 by disposing the first arm 3 and second arm 5 to the body 9 and the lever 15, respectively.

In other words, the turn-over spring 7 is configured such that when the plunger 11 is not pressed by the accelerator pedal 1, the pivot of the second arm 5 is biased to a side from the line that connects the pivots of the first arm 3 and the lever 15 and to the other side from the line, when the plunger 11 is pressed to the maximum stroke by the accelerator pedal 1.

The plunger 11 is provided with a guide rod 19 that has a constant cross-section smaller than the plunger 11 and extrudes from the surface opposite to the surface contacting the accelerator pedal 1, the body 9 is provided with an inner guide 21 into which the guide rod 19 is inserted and guided and an outer guide 23 that guides the circumference of the plunger 11, and the supporting spring 13 consists of a coil spring that is inserted in the space between the inner guide 21 and outer guide 23.

Therefore, The linearly sliding motion of the plunger 11 is more securely and stably supported by the inner guide 21 and outer guide 23, which ensures durability and reliability.

The inner guide 21 and the outer guide 23 may be integrally formed with the body 9.

According to the embodiment of the present invention, the lever 15 is provided with a long hole 27 and the plunger 11 is provided with a pin 25 that is inserted in the long hole 27, so that the lever 15 and the plunger 11 are connected by the pin 25 and the long hole 27 and the linearly sliding motion of the plunger 11 can be converted into the pivoting motion of the lever 15. On the contrary, the long hole 27 and pin 25 may also be provided to the plunger 11 and the lever 15, respectively.

The lever 15 has two branches, i.e. a first branch 29 that is connected with the plunger 11 and a second branch 31 that is connected with the turn-over spring 7, and the long hole 27 is formed in the first branch 29.

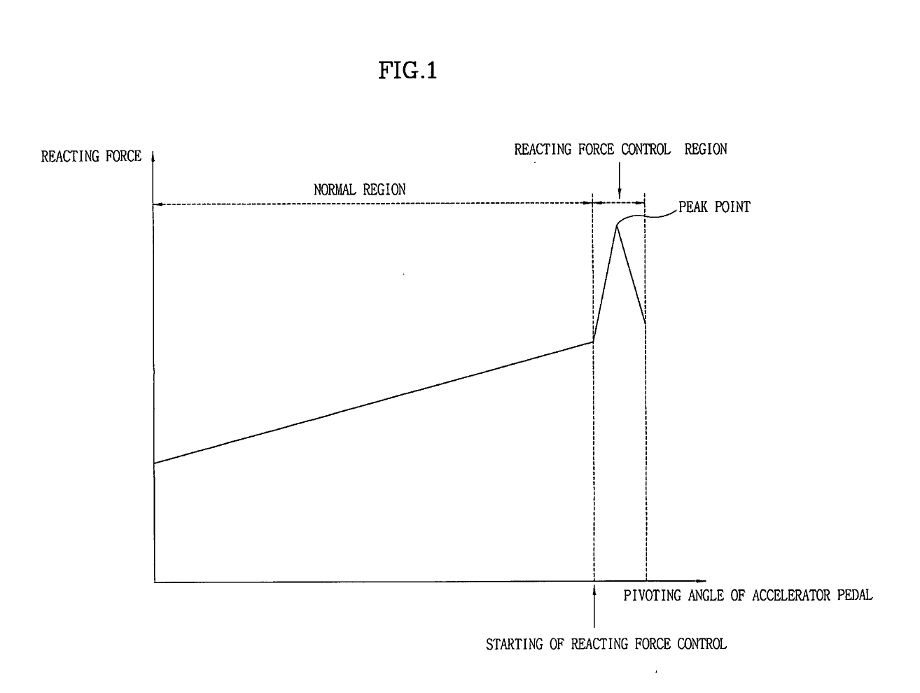

According to the operation of an embodiment configured as described above, when a driver presses the accelerator pedal 1, the entire stroke of the accelerator pedal 1 can be separated into two operating regions consisting of a normal region where the accelerator pedal 1 receives a reacting force linearly increasing as a return spring, which is provided to elastically support the accelerator pedal 1 in an initial state, deforms, and a reacting-force control region where the accelerator pedal 1 additionally receives an elastic force by the turn-over spring 7 as the accelerator pedal 1 presses the plunger 11 of the reacting-force controller according to the embodiment (see FIG. 1).

Because the body 9 is disposed at a specific position as described above, the reacting-force control region appears in the vicinity of the region where the pivot angle of the accelerator pedal 1 corresponds to the maximum as shown in FIG. 1.

As pressed by the accelerator pedal 1, the plunger 11 linearly slides and presses the supporting spring 13, and the sliding motion is transmitted to the turn-over spring 7 through the lever 15.

The turn-over spring 7 maintains a predetermined position with respect to the lever 15 because the first arm 3 functions as a pivot fixed to the body 9. When the linear sliding motion of the plunger 11 is converted into a pivoting motion of the lever 15 by the long hole 27 and the pin 25, the pivot of the second arm 5 moves with the lever 15 with respect to the pivots of the first arm 3 and the lever 15 and is biased from a side to the other side of the line that connects the pivots of the first arm 3 and the lever 15 as described above.

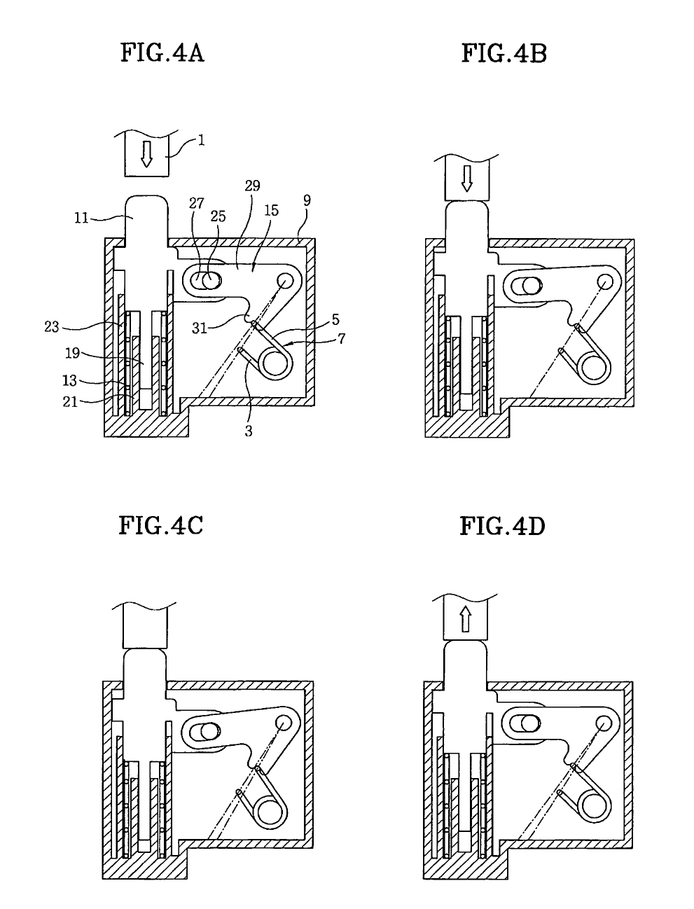

In more detail, the pivot of the second arm 5 is biased to a side from the line that connects the pivots of the first arm 3 and the lever 15 as shown in FIG. 4A. However, when the accelerator pedal 1 presses the plunger 11 and the lever 15 pivots, the above state changes to the state of FIG. 4C through FIG. 4B. As a result, the pivot of the second arm 5 is biased to the other side of the line that connects the pivots of the first arm 3 and lever 15.

According to the above configuration, in the state of FIG. 4B, the linear distance between the first arm 3 and second arm 5 is smaller than that in the state of FIG. 4A or 4C, so that the turn-over spring 7 provides larger elastic force than FIG. 4A or 4C.

Accordingly, the elastic force by the turn-over spring 7 operating as described above results in reacting force acting on the accelerator pedal 1 such as the reacting force in the reacting-force control region shown in FIG. 1. Further, the peak point of FIG. 1 appears in the state of FIG. 4B.

The reacting force in the reacting-force control region also includes the elastic force by the supporting spring 13. As the accelerator pedal 1 moves away from the plunger 11, that is, moves in the opposite direction, the supporting spring 13 returns the plunger 11 and the lever 15 as well as the turn-over spring 7 to their initial states.

Accordingly, the supporting spring 13 should be able to provide elastic force that is required to return the lever 15 without any external force and allows the pivot of the second arm 5 of the turn-over spring 7 to pass the state of FIG. 4B from FIG. 4C.

As the accelerator pedal 1 moves away from the plunger 11, the plunger 11, lever 15, and turn-over spring 7 returns to the state of FIG. 4D from FIG. 4C through FIG. 4B.

Therefore, when a driver presses the accelerator pedal 1 to the maximum stroke, a rapid variation of reacting force close to the maximum stroke by the turn-over spring 7 is transmitted to the driver as reacting force by the accelerator pedal 1, so that the driver can directly sense an instant catch through the accelerator pedal 1.

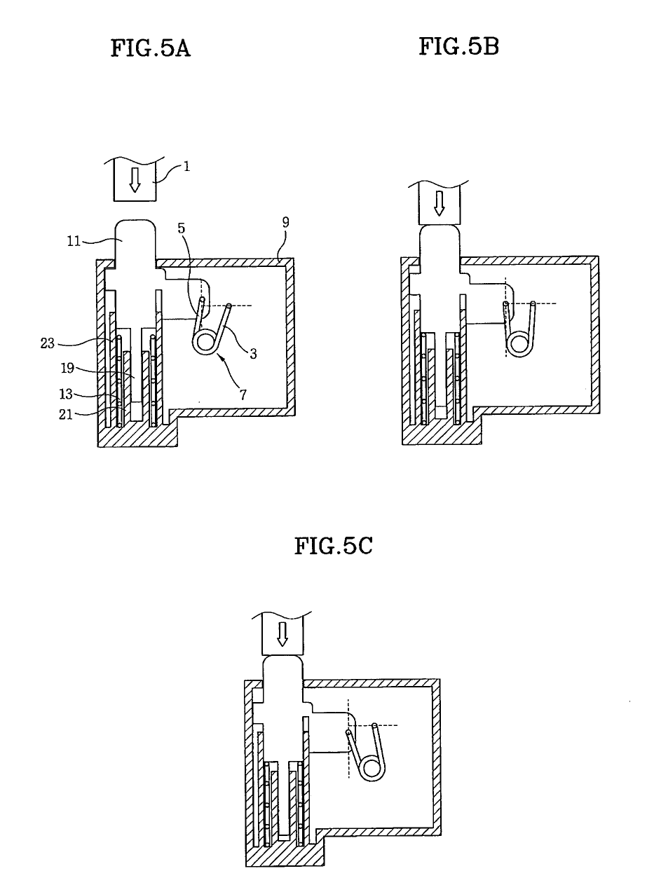

FIG. 5 shows another embodiment of the invention without the lever 15, unlike to the embodiments shown in FIGS. 2 and 3.

The power transmitting unit includes a body 9 that is fixed regardless of the motion of the accelerator pedal 1, a plunger 11 that is mounted in the body 9 and linearly slides as the accelerator pedal 1 pivots, and an elastic supporting spring 13 that pushes the plunger 11 toward the accelerator pedal 1. The turn-over spring 7 is disposed between the body 9 and the plunger 11, and increases or decreases in elastic force acting between the body 9 and the plunger 11 depending on the amount of linear motion of the plunger 11.

In the turn-over spring 7, when the plunger 11 is not pressed by the accelerator pedal 1, the pivot of the second arm 5 is biased to a side of the line extending from the pivot of the first arm 3 and vertically crossing the path of the plunger 11, as shown in FIG. 5A.

Further, when the plunger 11 is pressed to the maximum stroke by the accelerator pedal 1, the pivot of the second arm 5 is biased to the other side of the line extending from the pivot of the first arm 3 and vertically crossing the path of the plunger 11, as shown in FIG. 5C.

The plunger 11 should proceed to the state in FIG. 5B to be converted into the state of FIG. 5C from FIG. 5A. In the state of FIG. 5B, because the linear distance between the pivots of the first arm 3 and second arm 5 is shorter than that in the state of FIG. 5A or 5C, larger elastic force than that in FIG. 5A or 5C can be transmitted as reacting force to the accelerator pedal 1 through the plunger 11. As a result, a graph similar to that in the reacting-force control region shown in FIG. 1 is constructed.

Therefore, although the lever 15 is not provided between the plunger 11 and the turn-over spring 7, a driver can sense an instant catch by rapid variation of reacting force near the maximum stroke of the accelerator pedal 1 transmitted through the accelerator pedal 1.

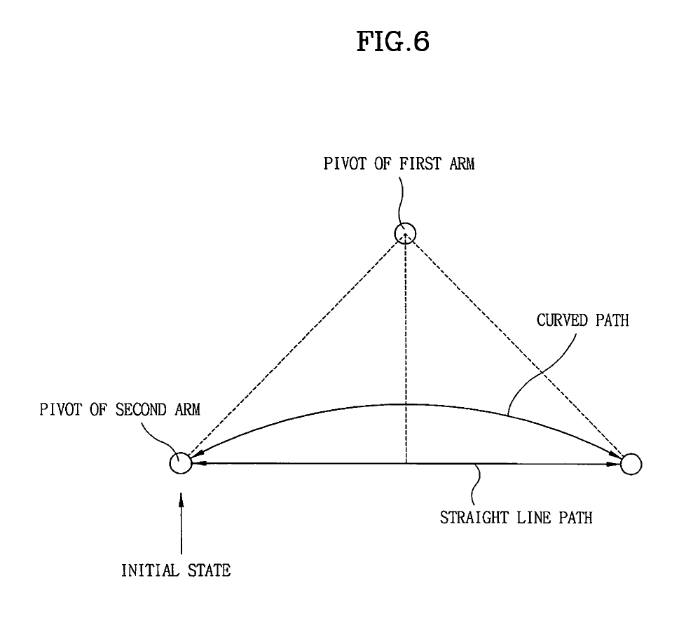

FIG. 6 illustrates the difference between the above two embodiments.

In FIG. 6, the linear path represents changes in the position of the pivot of the second arm 5 with respect to the pivot of the first arm 3 of the turn-over spring 7 depending on the linear motion of the plunger 11 when the lever is not provided. The curved path represents changes in the position of the pivot of the second arm 5 with respect to the pivot of the first arm 3 of the turn-over spring 7 depending on the pivoting motion of the lever 15 in the embodiment provided with the lever 15 when the plunger 11 is at the initial state, not pressed by the accelerator pedal 1, and the distance between the first and second arms 3 and 5 is given with the same state as in the linear path.

As seen from FIG. 6, the pivot of the second arm 5 more rapidly approaches and moves away from the pivot of the first arm 3 in the curved path as compared with the linear path, which implies that the elastic force by the turn-over spring 7 more rapidly changes.

Accordingly, more rapid and definite an instant catch appears in the embodiment provided with the lever 15 as compared with the embodiment without the lever 15, and a variety of characteristics of changes in the elastic force by the turn-over spring 7 can be obtained by adjusting the ratio of the distances from the pivot of the lever 15 to the plunger 11 and to the turn-over spring 7, so that the reacting-force controller for achieving desired reacting-force characteristics can be more freely designed.

Further, relative effects, such as cost saving, resulting from reducing the number of parts, can be obtained in the embodiments without the lever 15.

According to the present invention, when a driver presses an accelerator pedal to the maximum stroke, apart from the linear variation of the elastic force by a return spring provided to return the accelerator pedal, an additional momentary change in force is transmitted to the driver, so that a reacting-force controller for an accelerator pedal, which allows a driver to sense an instant catch when pressing the accelerator pedal to the maximum stroke, can be provided to a vehicle and also the vehicle's quality can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A reacting force controller for an accelerator pedal, comprising:
an accelerator pedal;
a turn-over spring that is composed of a circularly wound coil, a first arm and a second arm extending from the coil in two directions and respectively having pivots curved to be parallel with the central axis of the coil; and
a power transmitting unit that transmits pivoting motion of the accelerator pedal in a predetermined section of the entire pivoting stroke of the accelerator pedal to the turn-over spring,
wherein the turn-over spring is disposed such that the pivot of either the first or second arm approaches the pivot of the other arm, and is then returned by force continuously transmitted unidirectionally through the power transmitting unit from the accelerator pedal.

2. The reacting force controller as set forth in claim 1, wherein the power transmitting unit includes a body that is constantly fixed with respect to the motion of the accelerator pedal, a plunger that is provided in the body to slides linearly as the accelerator pedal pivots, a supporting spring that elastically supports the plunger that is to be pushed toward the accelerator pedal, and a lever that is provided in the body to pivot as the plunger linearly slides, and
wherein the turn-over spring is disposed between the body and the lever, so that the elastic force acting between the body and the lever increases or decreases depending on a pivoting angle of the lever.

3. The reacting force controller as set forth in claim 2, wherein the plunger is provided with a guide rod that has a constant cross-section smaller than the cross-section of the plunger and extrudes from a surface opposite to a surface contacting the accelerator pedal, and the body is provided with an inner guide into which the guide rod is inserted to be guided and an outer guide that guides a circumference of the plunger.

4. The reacting force controller as set forth in claim 3, wherein the supporting spring is a coil spring that is inserted in a space between the inner guide and the outer guide.

5. The reacting force controller as set forth in claim 2, wherein the lever and the plunger are connected by a pin and a long hole so that linear sliding motion of the plunger is converted into the pivoting motion of the lever.

6. The reacting force controller as set forth in claim 5, wherein the lever has a first branch and a second branch, the first branch being connected to the plunger and the second branch being connected to the turn-over spring.

7. The reacting force controller as set forth in claim 5, wherein the turn-over spring is configured such that the pivot of the second arm is biased to a side from a straight line that connects the pivots of the first arm and the lever when the plunger is not pressed by the accelerator pedal, and biased to the other side from the straight line that connects the pivots of the first arm and the lever when the plunger is pressed to the maximum stroke by the accelerator pedal.

8. The reacting force controller as set forth in claim 1, wherein the power transmitting unit includes a body that is constantly fixed with respect to the motion of the accelerator pedal, a plunger that is provided in the body to slide linearly as the accelerator pedal pivots, and a supporting spring that elastically supports the plunger that is to be pushed toward the accelerator pedal, and wherein the turn-over spring is disposed between the body and the plunger so that the elastic force by the turn-over spring acting between the body and the plunger increases or decreases depending on the amount of linear motion of the plunger.

9. The reacting force controller as set forth in claim 8, wherein the turn-over spring is configured such that the pivot of the second arm is biased to a side of a straight line perpendicular to the linear movement direction of the plunger from the pivot of the first arm when the plunger is not pressed by the accelerator pedal, and the pivot of the second arm is biased to the other side of the straight line perpendicular to the linear movement direction of the plunger from the pivot of the first arm when the plunger is pressed to the maximum stroke by the accelerator pedal.
